(19) United States
(12) Patent Application Publication
(10) Pub. No.: US 2013/0317155 A1
(43) Pub. Date: Nov. 28, 2013

(54) FLEXIBLE BENZOXAZINE RESIN

(71) Applicant: Integral Technology, Inc., Lake Forest, CA (US)

(72) Inventors: Christopher A. Hunrath, San Juan Capistrano, CA (US); Khang Tran, Lake Forest, CA (US)

(73) Assignee: Integral Technology, Inc., Lake Forest, CA (US)

(21) Appl. No.: 13/899,238

(22) Filed: May 21, 2013

Related U.S. Application Data
(60) Provisional application No. 61/650,939, filed on May 23, 2012.

(51) Int. Cl. C09J 179/00; C09J 7/00

(52) U.S. Cl. CPC C09J 179/00; C09J 7/00
USPC 524/311

(57) ABSTRACT

One or more embodiments contained herein disclose an adhesive for printed circuit board (PCB) applications. The improved adhesive may comprise a benzoxazine resin and a polyester plasticizer.

### RELATED APPLICATIONS

This application claims the benefit of priority under 35 U.S.C § 119(e) of U.S. Provisional Application No. 61/650,939 filed on May 23, 2012 and entitled “FLEXIBLE BENZOXAZINE RESIN,” which is hereby incorporated herein by reference in its entirety and is to be considered a part of this specification.

Further details regarding materials, products and processes of the embodiments of the application may be found in U.S. application Ser. No. 12/329,488, filed Dec. 5, 2008, entitled “IMPROVED INSULATING LAYER FOR RIGID PRINTED CIRCUIT BOARDS,” and Ser. No. 13/309,513 filed Dec. 1, 2011, entitled “IMPROVED ADHESIVE FILM LAYER FOR PRINTED CIRCUIT BOARD APPLICATIONS,” the entirety of each of which are hereby incorporated by reference and are considered to be a part of this specification.

### BACKGROUND

1. Field

The disclosure herein relates to printed circuit boards, and more particularly, adhesive resin film layers for use in the manufacture of rigid and flexible printed circuit boards. The attached Appendix (also attached to the aforementioned provisional) is hereby incorporated by reference in its entirety as part of this specification.

2. Description of the Related Art

Printed circuit boards (PCB) comprise one or more layers of electrically conductive material such as copper and one or more electrically insulating layers such as dielectrics. Multilayer PCBs typically comprise two or more inner and/or surface conductive layers formed over and separated by a plurality of insulating layers with holes, vias, and through holes providing electrical connection between the various inner conductive layers and other inner conductive layers and/or the surface conductive layers.

### SUMMARY

In an embodiment, a composition of matter comprises a thermoset resin and a polyester-based plasticizer. In some embodiments, the thermoset resin comprises a benzoxazine resin. In some embodiments, the benzoxazine resin may be present in the composition in an amout of about 75% by weight to about 95% by weight based on the total weight of the composition. In some embodiments, the benzoxazine resin may be present in the composition in an amout of about 50% by weight to about 95% by weight based on the total weight of the composition.

In some embodiments, a composition of matter comprises an uncured benzoxazine resin, the uncured benzoxazine resin being present in the composition in an amount in the range of about 75% by weight to about 95% by weight based on the total weight of the composition; and a polyester plasticizer being present in the composition in an amount in the range of about 5% by weight to about 25% by weight based on the total weight of the composition. In some embodiments, the uncured benzoxazine resin may be present in the composition in an amount in the range of about 50% by weight to about 95% by weight based on the total weight of the composition and a polyester plasticizer being present in the composition in an amount in the range of about 5% by weight to about 25% by weight based on the total weight of the composition. In some embodiments, the composition further comprises a cured benzoxazine resin, the cured benzoxazine resin being present in an amount in the range of about 5% by weight to about 25% by weight based on the total weight of the composition. In some embodiments, the uncured benzoxazine resin is present in an amount of about 85% or 80% by weight based on the total weight of the composition.

In some embodiments, an adhesive film layer comprises about 75 wt % to about 95 wt % benzoxazine resin and about 5 wt % to about 25 wt % of polyester plasticizer. In some embodiments, an adhesive film layer comprises about 50 wt % to about 95 wt % benzoxazine resin and about 5 wt % to about 25 wt % of polyester plasticizer. In some embodiments, the adhesive film layer comprises about 85 wt % benzoxazine resin and about 15 wt % polyester plasticizer. In some embodiments, the adhesive film layer may also comprise about 1 wt % to about 10 wt % synthetic rubber.

In some embodiments, a layered film comprises an adhesive film layer comprising about 75 wt % to about 95 wt % of an uncured benzoxazine resin and about 5 wt % to about 25 wt % of polyester plasticizer. In some embodiments, a layered film comprises an adhesive film layer comprising about 50 wt % to about 95 wt % of an uncured benzoxazine resin and about 5 wt % to about 25 wt % of polyester plasticizer.

### BRIEF DESCRIPTION OF DRAWINGS

FIG. 1A and 1B illustrate examples of uses of an adhesive layer with dielectric film.

FIG. 2 is a differential scanning calorimetry scan of an adhesive layer in accordance with at least some of the examples of the present disclosure.

### DETAILED DESCRIPTION

Several aspects of the PCB manufacturing and assembly processes subject PCB components to strain or stress (e.g., mechanical, thermal, physical, chemical, and the like). For example, manufacturing exposes PCBs to a range of temperatures, including high soldering temperatures which have increased even more in response to the industry's recent adoption of lead-free processes. Strain can cause defects in components, resulting in electrical and/or mechanical failure. For example, thermal strain arising from increasing temperatures can cause cracks in the PCB components, including pad cratering, a type of crack typically occurring in insulating layers that engage surface conductive layers. Other thermally induced defects from soldering at assembly include blisters, delamination, cracks in copper foil and plating.

Adhesive film layers are used in the PCB assembly process to bind various conductive and insulating layers together. Currently used adhesive film layers are impregnated with fiberglass or other fillers which can cause plating defects, slow laser drilling, provide pathways for filament growth, and prevent via pitch reduction. There is a need for adhesive film layers free of fiberglass which are more stable and damage resistant that allow for faster laser drilling, reduction of plating defects such as folds in both laser and mechanically drilled vias which makes vias easier to copper fill, eliminate filament growth pathways, and allow for significant via pitch reductions.

One important type of PCBs on the market today is flexible or “flex” PCBs. These flexible printed circuit boards may be used in applications where the circuit board may need to flex and bend without fracture. Flexible printed circuit boards may generally be formed of three main components: conductors, dielectrics and adhesives. Conductors may include rolled and annealed copper foil (most commonly), aluminum foil, or printed inks such as silver flake or copper/tin powders. Dielectrics may include polyimide film (such as KAPTON® from DUPONT®), polyester film (such as MYLAR from DUPONT®), or thin fiberglass laminate. Thin fiberglass laminate, however, may have limited utility in the field of flex PCBs because of its limited flexibility. Adhesives used in the manufacture of flex PCBs may include acrylic (most commonly), epoxy with butyl or nitrile rubber added, ethylene vinyl acetate (EVA), or polyester.

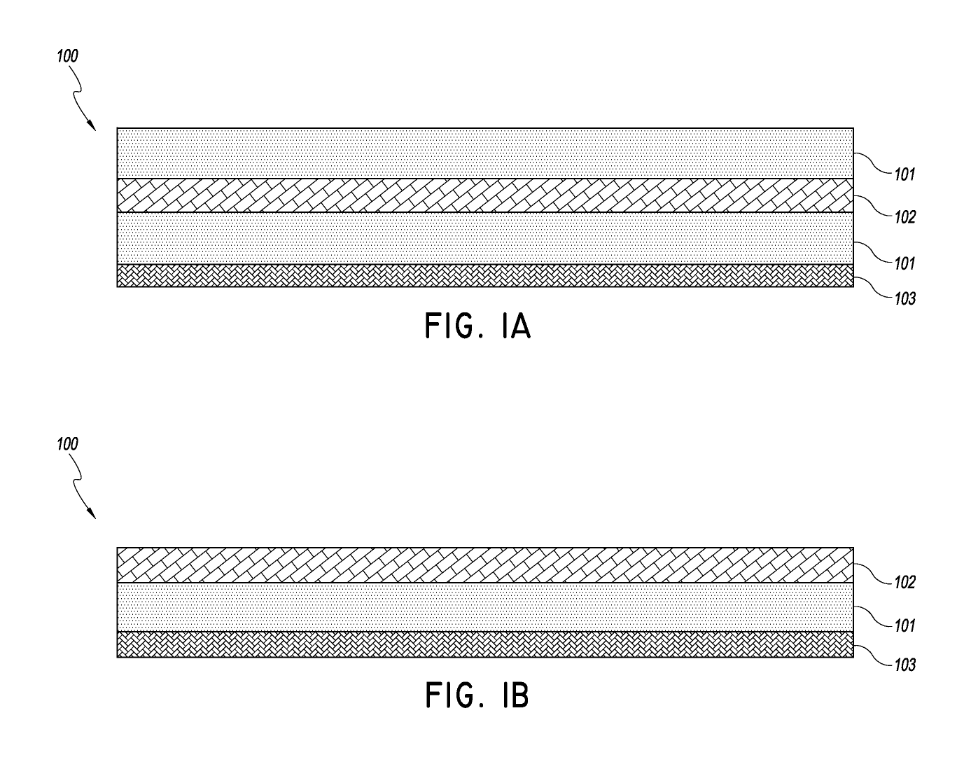

The manufacture of PCBs may include a step where one or more adhesive layers are combined with a dielectric. As illustrated by the combination (100) of adhesive layers and dielectric film shown in FIG. 1A, an adhesive layer 101 may be adhered to a top side of a dielectric layer 102, such as a polyimide layer (such as KAPTON). A protective polyester (such as MYLAR) release layer 103 may then be adhered to at least one adhesive layer that is not adhered to the polyimide layer. In some embodiments, as illustrated in FIG. 1B, an adhesive layer 101 may be adhered to a bottom side of a dielectric layer 102 and a polyester release layer 103 may be adhere to at least one adhesive layer that is not adhered to the polyimide layer. Adhesive layers generally must be partially cured or “B-stage” in order to bond layers of the PCBs together.

In order to make adhesive layers more flexible, additives may be added to them. Specifically, additives may be added to epoxy systems. However, these additives may reduce the thermal performance of the epoxy. For example, additives may increase the coefficient of thermal expansion of the adhesive and lower the glass transition temperature. Adhesive systems that do not include an epoxy component generally have lower thermal performance. The reduced thermal performance inherent in non-epoxy systems and epoxy systems including certain additives present challenges where lead-free assembly methods are carried out at a high temperature, which may damage the aforementioned adhesive systems.

An adhesive for flexible PCBs may provide desirable properties as compared to the adhesive systems of the prior art. An adhesive for flexible PCB applications may include a resin with a benzoxazine backbone. The adhesive may also include a polyester plasticizer mixed in with the bezoxazine-based resin. In some embodiments, the polyester plasticizer may be a mixed dibasic acid polyester. According to some embodiments, the adhesive does not include a phenoxy resin component. According to some embodiments, the adhesive does not include an epoxy resin component. According to some embodiments, the adhesive does not include a phenoxy resin component or an epoxy resin component. In some embodiments, the adhesive does not include butyl or nitrile rubber. The adhesive may be able to maintain favorable flexibility properties, even after it is partially or fully cured. In some embodiments, the adhesive may be used for flexible and rigid PCBs.

Many materials may be used as a base resin for making flexible adhesive films for flex PCB manufacturing. One particularly beneficial resin is benzoxazine. One example of commercially available benzoxazine resin is Henkel Benzoxazine 99110, the data sheets and physical testing data of which are hereby incorporated by reference in their entirety. Other adhesive materials may include, without limitation, thermoset and/or thermoplastic plastics, such as, for example, phenoxy resins, polyethers, polyimides, polyesters, fluorinated hydrocarbons, polymers, polyacrylates, liquid crystal polymers, synthetic fibers, aramids, fluorocarbons, and the like. Adhesives can also comprise a mixture of one or more of the thermoset and/or thermoplastic plastic materials or a mixture of one or more of the plastic materials with other materials (e.g., fillers, hardeners, etc.). Additives generally can improve flexibility, adhesion, coatability, and shelf life of an uncured film but can decrease the thermal performance. However, selection of an appropriate additive may allow for the retention of benefits gained with the use of benzoxazine.

The adhesive film layers in accordance with embodiments disclosed herein are composed of a thermoset resin and a polyester-based plasticizer. In some embodiments, the thermoset resin comprises a benzoxazine resin.

In some embodiments an adhesive may include both cured and uncured benzoxazine resin. For example, a composition may comprise an uncured benzoxazine resin present in an amount in the range of about 75% by weight to about 95% by weight based on the total weight of the composition and a polyester plasticizer present in the composition in an amount in the range of about 5% by weight to about 25% by weight based on the total weight of the composition. In some embodiments, a composition may comprise an uncured benzoxazine resin present in an amount in the range of about 50% by weight to about 95% by weight based on the total weight of the composition, a polyester plasticizer present in the composition in an amount in the range of about 5% by weight to about 25% by weight based on the total weight of the composition, and other additional components, including but not limited to fillers and rubber. In some embodiments, the uncured benzoxazine resin may be present in an amount in the range of about 50% by weight to about 65% by weight; 60% by weight to about 75% by weight; 70% by weight to about 85% by weight; 80% by weight to about 95% by weight, and the like. In some embodiments, the uncured benzoxazine resin may be present in an amount of about 85% or about 80% based on the total weight of the composition of the adhesive. The composition may also comprise an amount of cured benzoxazine resin. The cured benzoxazine resin may be present in the composition in an amount in the range of 5% by weight to 25% by weight based on the total weight of the composition of the adhesive. The cured benzoxazine resin may also be present in an amount of about 5% by weight to about 10% by weight, about 10% by weight to about 20% by weight, about 15% by weight to about 25% by weight, about 20% by weight to about 25% by weight, and the like. According to some embodiments, the adhesive is substantially all uncured and/or cured benzoxazine resin (95%-100% by weight based on the total weight of the composition of the adhesive). In some embodiments, the adhesive film layer may also comprise about 1% by weight to about 10% by weight synthetic rubber.

The amount of polyester-based plasticizer by weight, based on the total weight of the adhesive composition, may vary. According to an embodiment, the weight percentage of polyester-based plasticizer may comprise between about 1% and about 25% by weight of the total adhesive composition weight. According to other embodiments, the weight percentage of polyester-based plasticizer may comprise between about 5% and about 20% by weight, between about 10% and about 20% by weight, between about 5% and about 10% by weight, and the like, based on total weight of the adhesive composition.

In some embodiments, one or more inorganic fillers may be added to the adhesive composition. The filler may include calcium carbonate, mica, talc, silicon dioxide, and the like. The filler may be present in the composition in an amount in the range of 5% to 50% by weight based on the total weight of the composition of the adhesive layer. In other embodiments, the filler may be present in the composition in an amount in the range of 5% by weight to 10% by weight, 10% by weight to 20% by weight, 15% by weight to 25% by weight, 20% by weight to 25% by weight, 30% to 40% by weight, or 40% to 50% by weight.

The filler used should be substantially wettable by the benzoxazine resin in the adhesive layer composition. In some embodiments, the average particle size of the filler is less than or equal to 50 microns, less than or equal to 40 microns, or less than or equal to 30 microns. Preferably, the average particle size of the filler is less than 20 microns.

A filler used in the compositions described herein may be able to modify the expansion properties of the adhesive layer, its dielectric attributes, its flow, flexibility, and toughness.

Additionally, the adhesive can be substantially halogen free, non-glass reinforced, substantially lead free, substantially Bisphenol A free, and substantially fiberglass free. The adhesive film layers can be substantially free of lead. In one embodiment, the adhesive film layers are substantially free of halogen. In another, the adhesive film layers are substantially free of fiberglass. The adhesive film layers can be substantially free of Bisphenol A. In some embodiments, the adhesive film layers do not require a bonding treatment, oxidation or other special treatments for adhesion. In some embodiments, the adhesive film layers' viscosity drops upon heating to flow and fill complex circuits and micro vias and provide leveling of the PCB. In some embodiments, the glass transition temperature of the adhesive films may range from about 160° C. to about 210° C.; about 170° C. to about 200° C.; and about 180° C. to about 190° C.

The adhesive layers may be manufactured according to methods known in the art. A non-limiting example of the manufacture of the disclosed adhesive layers proceeds as follows. In some embodiments, the uncured thermoset resin is first heated above its melting temperature. A solvent, for example methyl ethyl ketone (MEK) is added, and then the polyester resin is added to the liquid thermoset resin. The mixture is heated and blended until homogenous, and then formed into a film. The film is preferably coated onto a carrier such as Mylar, and formed in sheets of 12 inch, 19 inch, or other suitable widths. The film is then dried to remove the solvent. Alternatively, the thermoset and polyester resins can first be mixed together, then heated above the melting temperature and blended until homogenous, or the polyester resin can be first heated above its melting temperature, the thermoset resin added, and the mixture heated and blended until homogenous.

An adhesive including benzoxazine resin and a polyester additive, such as a polyester-based plasticizer, may exhibit several desirable benefits. For example, the adhesive may have a longer shelf life and stability as a B-stage resin as compared to adhesive systems of the prior art. The adhesive system may also have better flame retardancy as compared to adhesive systems of the prior art. Also, the adhesive may exhibit improved adhesion to substrates, including dielectric substrates, as compared to adhesive systems of the prior art.

Glass transition temperatures of flexible adhesives typically range from about 40° C. for acrylic based adhesives to about 130° C. for epoxy based adhesives. During assembly (e.g. attaching of electronic components) with lead free solder, the temperatures of the flexible PCB will range from 210 to 240° C., thereby indicating a significant softening of the PCB and thermal expansion. However, the disclosed adhesives comprising benzoxazine may have improved thermal performance at assembly as compared to adhesives containing acrylic or epoxy polymers.

Plasticizers for flexible adhesives generally decrease the thermal performance of all base resins. However, without being bound to a particular theory, due to the improved thermal performance of benzoxazine, the effect of the addition of the plasticizers is minimal. Moreover, the choice of polyester may also be advantageous since thermal performance is generally higher compared to many forms of rubber. In some embodiments, to achieve the disclosed adhesives, the benzoxazine may be placed into a “B” stage (semi-cured) film while the plasticizer is kept in solution until the benzoxazine is fully cured.

Additional embodiments are disclosed in further detail in the following examples, which are not in any way intended to limit the scope of the claims.

As a non-limiting example, to prepare a film and subsequently analyze its characteristics, a solution with mixture of the resins and additives is first prepared. A lab coat with a wire-wound rod (meyer rod) system is used to generate the film, and the film is subsequently dried. Alternatively, a slot die coating system may be used to create the film. The film is then peeled or transferred on to a substrate for testing. When the film is evaluated for thermal, mechanical or electrical performance, the film is fully cured. For thermal evaluations, the film itself or the film within a PCB may be tested. For mechanical or electrical evaluations, the PCB containing the film may be tested. Pre-cure tests are generally performed on the film itself and include shelf life and usability for the PCB manufacturer.

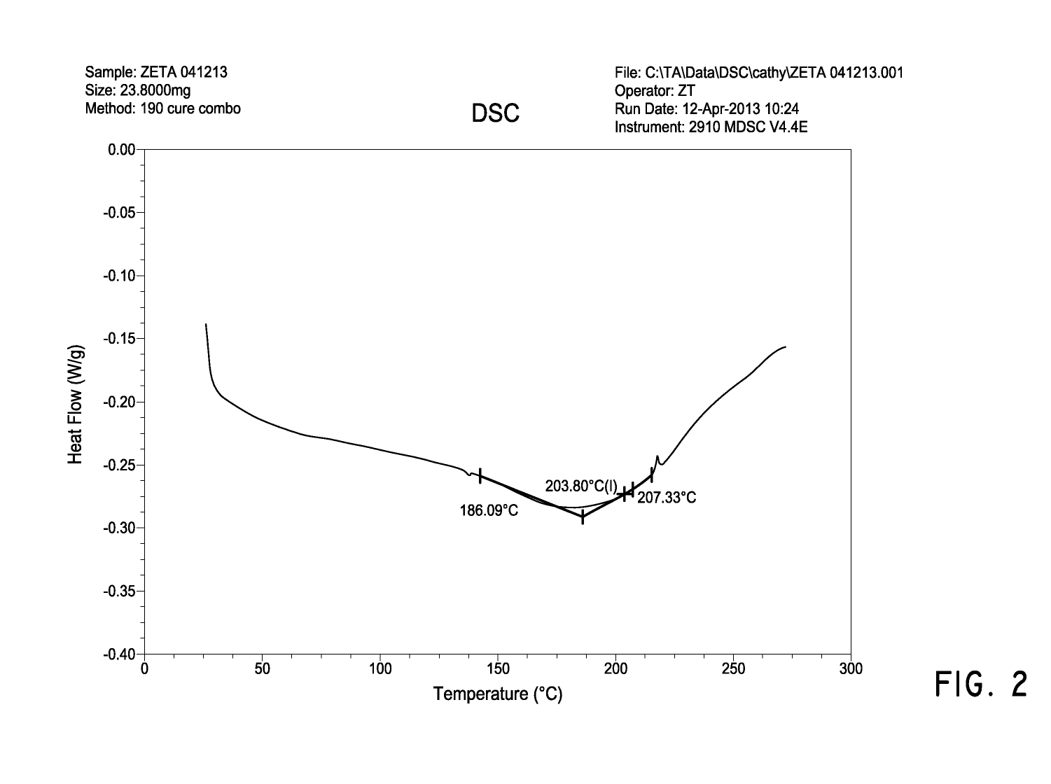

FIG. 2 shows a differential scanning calorimetry (DSC) scan of one example of a cured benzoxazine-based adhesive film according to some of the disclosed embodiments and comprising 62% of benzoxazine; 16% talc filler; 12% epoxy resin; and 10% plasticizer. The scan shows that the adhesive film has a glass transition temperature (T_{g}) around 200° C., a significant improvement over currently available materials for flexible circuit manufacture.

Other exemplary compositions of the disclosed invention are described in Table 1. All percentages are given as weight percent. The exemplary materials given in the table below can be substituted with other materials known in the art to achieve the given purposes. The purposes given in the table also are exemplary and are not given to be bound to a particular theory; thus, the materials may also be used to achieve other purposes.

| Exemplary | | | | | | | |
|---|---|---|---|---|---|---|---|
| Material | Purpose | Example 1 | Example 2 | Example 3 | Example 4 | Example 5 | Example 6 |
| Benzoxazine | High | 62% | 53.75% | 82% | 63.25% | 64.5% | 83% |
| | temperature | | | | | | |
| | performance | | | | | | |
| Phenoxy | Film former, | — | 8% | 8% | — | — | 5% |
| | toughener | | | | | | |
| Polyester | Flexibility | 10% | 15% | 10% | 12% | 12% | 12% |
| Synthetic | Flexibility, | — | — | — | 0.5% | — | — |
| Rubber | flow control | | | | | | |
| Epoxy | Flow control | 12% | — | — | — | — | — |
| Talc | Flow | 16% | — | — | 14% | — | — |
| | control, | | | | | | |
| | lower | | | | | | |
| | coefficient | | | | | | |
| | of thermal | | | | | | |
| | expansion | | | | | | |
| Nano Clay | Flow control | — | 15% | — | — | — | — |
| PTFE | Flow | — | — | — | — | 18% | — |
| (Teflon) | control, | | | | | | |
| Powder | lowers | | | | | | |
| | dielectric | | | | | | |
| | constant | | | | | | |
| Amino silane | Adhesion | — | 0.25% | — | — | 0.5% | — |
| | promoter | | | | | | |
| Epoxy | Adhesion | — | — | — | 0.25% | — | — |
| Silane | promoter | | | | | | |
| Cresyl | Improved | — | 8% | — | 10% | 5% | — |
| Diphenyl | flammability | | | | | | |
| Phosphate | control | | | | | | |

Although the foregoing description has shown, described, and pointed out the fundamental novel features of the embodiments disclosed herein, it will be understood that various omissions, substitutions, and changes in the form of the detail of the apparatus as illustrated, as well as the uses thereof, may be made by those skilled in the art, without departing from the spirit or scope of the disclosed embodiments. Consequently, the scope of the present application should not be limited to the foregoing discussion, but should be defined by the appended claims.

What is claimed is:

1. A composition of matter comprising a thermoset resin and a polyester plasticizer.

2. The composition of claim 1, wherein the thermoset resin comprises benzoxazine resin.

3. The composition of claim 1, comprising about 5 wt % to about 25 wt % polyester plasticizer.

4. The composition of claim 2, comprising about 75 wt % to about 95 wt % benzoxazine resin.

5. The composition of claim 1, wherein the thermoset resin comprises an uncured benzoxazine resin, the uncured benzoxazine resin being present in the composition in an amount in the range of about 75% by weight to about 95% by weight based on the total weight of the composition; and the polyester plasticizer being present in the composition in an amount in the range of about 5% by weight to about 25% by weight based on the total weight of the composition.

6. The composition of claim 5, wherein the composition further comprises a cured benzoxazine resin, the cured benzoxazine resin being present in an amount in the range of about 5% by weight to about 25% by weight based on the total weight of the composition.

7. The composition of claim 5, wherein the uncured benzoxazine resin is present in an amount of about 85% or about 80% by weight based on the total weight of the composition.

8. An adhesive film layer comprising about 75 wt % to about 95 wt % benzoxazine resin and about 5 wt % to about 25 wt % of polyester plasticizer.

9. The adhesive film layer of claim 8, comprising about 85 wt % benzoxazine resin and about 15 wt % polyester plasticizer.

10. A layered film comprising an adhesive film layer, wherein the adhesive film layer comprises about 75 wt % to about 95 wt % of an uncured benzoxazine resin and about 5 wt % to about 25 wt % of polyester plasticizer.

11. A printed circuit board comprising a layered film, wherein the layered film comprises an adhesive layer, wherein the adhesive film layer comprises about 75 wt % to about 95 wt % of an uncured benzoxazine resin and about 5 wt % to about 25 wt % of polyester plasticizer.
